(19) United States
(12) Patent Application Publication
(10) Pub. No.: US 2016/0043896 A1
(43) Pub. Date: Feb. 11, 2016

(54) HOME NETWORK MANAGER FOR HOME AUTOMATION

(71) Applicant: Fibar Group sp. z o.o., Poznan (PL)

(72) Inventor: Maciej Fiedler, Poznan (PL)

(21) Appl. No.: 14/451,965

(22) Filed: Aug. 5, 2014

(51) Int. Cl. H04L 12/24; H04L 12/28

(52) U.S. Cl. CPC H04L 41/0803; H04L 12/2803; H04L 2012/2841

(57) ABSTRACT

A home network manager may be operable to provide management of one or more network elements which may be coupled to the home network manager for home automation. One or more add-on devices, which are newly connected to the home network manager may be detected by the home network manager. The home network manager may be operable to configure the newly connected one or more add-on devices. The Home network manager may then be operable to provide, with inclusion of the one or more add-on devices, the management for the home automation. The home network manager may be operable to couple to the one or more network elements using Z-wave wireless communication and/or other communications methods and/or protocols. The home network manager and the coupled one or more network elements may communicate with each other in a network environment.

### FIELD OF THE DISCLOSURE

Certain embodiments of the disclosure relate to home automation systems. More specifically, certain embodiments of the disclosure relate to a method and system for a home network manager for home automation.

### BACKGROUND OF THE DISCLOSURE

Existing methods and systems for providing device monitoring or control for home automation can be costly, cumbersome and inefficient. Further limitations and disadvantages of conventional and traditional approaches will become apparent to one of skill in the art, through comparison of such systems with the present disclosure as set forth in the remainder of the present application with reference to the drawings.

### BRIEF SUMMARY OF THE DISCLOSURE

A system and/or method for a home network manager for home automation, substantially as shown in and/or described in connection with at least one of the figures, as set forth more completely in the claims.

In one embodiment, the invention provides a method including providing, by a home network manager, management of one or more network elements which are coupled to the home network manager for home automation, detecting one or more add-on devices which are newly connected to the home network manager, configuring the newly connected one or more add-on devices, and providing, by the home network manager with inclusion of the one or more add-on devices, the management for the home automation.

In some embodiments, the method also includes coupling to the one or more network elements using Z-wave wireless communication.

In some embodiments, the home network manager and the coupled one or more network elements communicate with each other in a mesh network environment.

In some embodiments, the method also includes providing user friendly interface to one or more computing devices for managing and controlling the home network manager.

In some embodiments, the one or more computing devices comprise one or more of a PC, a mobile phone, a smart phone, and a tablet.

In some embodiments, the method also includes communicating with the one or more computing devices via a communication network.

In some embodiments, the one or more computing devices manage and control the home network manager either locally or remotely.

In some embodiments, the one or more computing devices manage and control the home network manager utilizing a downloaded application which is associated with the home network manager.

In some embodiments, the method also includes tracking locations of one or more of the computing devices.

In some embodiments, the method also includes managing the one or more network elements based on the tracking.

In some embodiments, the method also includes connecting to the one or more add-on devices with an open interface.

In some embodiments, the home network manager is a compact device with a size of 90 mm long, 90 mm wide and 33 mm high.

In some embodiments, the home network manager comprises an energy efficient processor.

In some embodiments, the home network manager comprises a recovery module for providing system backup and recovery.

In some embodiments, the home network manager comprises a message service module for providing a notification to a user of the home network manager.

In some embodiments, the home network manager comprises an access control module for providing user's access control and user's rights management.

In another embodiment, the invention provides a home network manager. The home network manager includes one or more circuits, wherein the one or more circuits are operable to provide management of one or more network elements which are coupled to the home network manager, detect one or more add-on devices which are newly connected to the home network manager, self-configure the newly connected one or more add-on devices, and provide, with inclusion of the one or more add-on devices, the management for the home automation.

In some embodiments, the one or more circuits are operable to couple to the one or more network elements using Z-wave wireless communication.

In some embodiments, the home network manager and the coupled one or more network elements communicate with each other in a mesh network environment.

In some embodiments, the one or more circuits are operable to provide user friendly interface to one or more computing devices for managing and controlling the home network manager.

In some embodiments, the one or more computing devices comprise one or more of a PC, a mobile phone, a smart phone, and a tablet.

In some embodiments, the one or more circuits are operable to communicate with the one or more computing devices via a communication network.

In some embodiments, the one or more computing devices manage and control the home network manager either locally or remotely.

In some embodiments, the one or more computing devices manage and control the home network manager utilizing a downloaded application which is associated with the home network manager.

In some embodiments, the one or more circuits are operable to track locations of one or more of the computing devices.

In some embodiments, the one or more circuits are operable to manage the one or more network elements based on the tracking.

In some embodiments, the one or more circuits are operable to connect to the one or more add-on devices with an open interface.

In some embodiments, the home network manager is a compact device with a size of 90 mm long, 90 mm wide and 33 mm high.

In some embodiments, the home network manager comprises an energy efficient processor.

In some embodiments, the home network manager comprises a recovery module for providing system backup and recovery.

In some embodiments, the home network manager comprises a message service module for providing a notification to a user of the home network manager.

In some embodiments, the home network manager comprises an access control module for providing user's access control and user's rights management.

In yet another embodiment, the invention provides a non-transitory computer readable medium having stored thereon, a computer program having at least one code section, the at least one code section being executable by a computer for causing the computer to perform steps comprising providing, by a home network manager, management of one or more network elements which are coupled to the home network manager for home automation, detecting one or more add-on devices which are newly connected to the home network manager, configuring the newly connected one or more add-on devices, and providing, by the home network manager with inclusion of the one or more add-on devices, the management for the home automation.

In some embodiments, the at least one code section comprises code for coupling to the one or more network elements using Z-wave wireless communication.

In some embodiments, the home network manager and the coupled one or more network elements communicate with each other in a mesh network environment.

In some embodiments, the at least one code section comprises code for providing user friendly interface to one or more computing devices for managing and controlling the home network manager.

In some embodiments, the one or more computing devices comprise one or more of a PC, a mobile phone, a smart phone, and a tablet.

In some embodiments, the at least one code section comprises code for communicating with the one or more computing devices via a communication network.

In some embodiments, the one or more computing devices manage and control the home network manager either locally or remotely.

In some embodiments, the one or more computing devices manage and control the home network manager utilizing a downloaded application which is associated with the home network manager.

In some embodiments, the at least one code section comprises code for tracking locations of one or more of the computing devices.

In some embodiments, the at least one code section comprises code for managing the one or more network elements based on the tracking.

In some embodiments, the least one code section comprises code for connecting to the one or more add-on devices with an open interface.

In some embodiments, the home network manager is a compact device with a size of 90 mm long, 90 mm wide and 33 mm high.

In some embodiments, the home network manager comprises an energy efficient processor.

In some embodiments, the home network manager comprises a recovery module for providing system backup and recovery.

In some embodiments, the home network manager comprises a message service module for providing a notification to a user of the home network manager.

In some embodiments, the home network manager comprises an access control module for providing user's access control and user's rights management.

In yet another embodiment, the invention provides a method of managing one or more elements in a home network for home automation using an electronic home network manager. The method comprises coupling the one or more elements to the electronic home network manager via the home network, and detecting via the electronic home network manager whether one or more elements has been coupled to the electronic home network manager via the home network. The method also comprises, in response to detecting one or more elements has been coupled to the electronic home network manager, configuring the coupled one or more elements to communicate with the electronic home network manager, and communicating via the electronic home network manager a programmed function the configured one or more elements.

In some embodiments, the coupling the one or more elements to the electronic home network manager comprises coupling the one or more elements to the electronic home network manager with Z-wave wireless communication protocol.

In some embodiments, the method further comprises accessing the electronic home network manager via an electronic device including one or more of a PC, a mobile phone, a smart phone, and a tablet.

In some embodiments, the method further comprises tracking via the electronic home network manager a geo-location of the electronic device.

In some embodiments, the method further comprises managing via the electronic device the one or more configured elements based on the tracking.

In some embodiments, the electronic home network manager further comprises a recovery module. The method further comprises backing up information of the electronic home network manager to the recovery module.

In some embodiments, the electronic home network manager further comprises a message service module. The method further comprises delivering a notification to the one or more configured elements with the message service module.

In some embodiments, the electronic home network manager further comprises an access control module. The method further comprises controlling access to the electronic home network manager with the access control module.

In some embodiments, the electronic home network manager is further coupled to a different configured networked element. The method further comprises communicating at least a portion of the programmed function via the home network between the configured one or more elements and the different configured networked element.

In yet another embodiment, the invention provides a home management system. The home management system comprises an electronic element configured to perform a home automation function, and an external device interface configured to be coupled to the electronic element, and, when coupled, to provide control information to the coupled electronic element. The home management system also comprises a processor coupled to the external device interface, and configured i) to detect whether the electronic element has been coupled to the external device interface, ii) in response to detecting the electronic element has been coupled to the external device interface, to configure the coupled electronic element to communicate with the processor, and iii) to communicate a programmed function to the configured electronic element.

In some embodiments, the external device interface communicates to the electronic element with Z-wave wireless communication protocol.

In some embodiments, the home management system further comprises an electronic device configured to access information of the processor. The electronic device comprises one or more of a PC, a mobile phone, a smart phone, and a tablet.

In some embodiments, the home management system further comprises a localization module configured to track via a geo-location of the electronic device. The processor is further configured to manage the configured electronic element based on the tracking.

In some embodiments, the home management system further comprises a memory configured to store operational information of the home management system, and a recovery module configured to back up the stored operational information to the recovery module.

In some embodiments, the home management system further comprises a message service module configured to deliver a notification to the configured electronic element.

In some embodiments, the home management system further comprises an access control module configured to control access to the home management system.

In some embodiments, the home management system further comprises a different configured networked element. The configured electronic element is further configured to communicate at least a portion of the programmed function to the different configured networked element.

In still another embodiment, the invention provides a non-transitory computer readable medium for managing one or more elements in a home network for home automation using an electronic home network manager. The non-transitory computer readable medium having stored thereon, a computer program having at least one code section. The at least one code section being executable by a computer for causing the computer to perform steps comprising coupling the one or more elements to the electronic home network manager, detecting whether one or more elements has been coupled to the electronic home network manager via the home network, in response to detecting one or more elements has been coupled to the electronic home network manager, configuring the coupled one or more elements to communicate with the electronic home network manager, and communicating a programmed function the configured one or more elements.

In some embodiments, the electronic home network manager is further coupled to a different configured networked element. The steps further comprise communicating at least a portion of the programmed function via the home network between the configured one or more elements and the different configured networked element.

In some embodiments, the electronic home network manager further comprises a message service module. The steps further comprise delivering a notification to the one or more configured elements with the message service module.

Various advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an example home network, in accordance with an example embodiment of the disclosure.

FIG. 2 is a block diagram illustrating an example home network manager, in accordance with an example embodiment of the disclosure.

FIG. 3 is a flow chart illustrating example steps for providing management by a home network manager, in accordance with an example embodiment of the disclosure.

### DETAILED DESCRIPTION OF THE DISCLOSURE

As utilized herein the terms “circuit” and “circuitry” refer to physical electronic components (i.e. hardware) and any software and/or firmware (“code”) which may configure the hardware, be executed by the hardware, and/or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, a device/module/circuitry/etc. is “operable” to perform a function whenever the device/module/circuitry/etc. comprises the necessary hardware and code (if any is necessary) to perform the function, regardless of whether performance of the function is disabled, or not enabled, by some user-configurable setting.

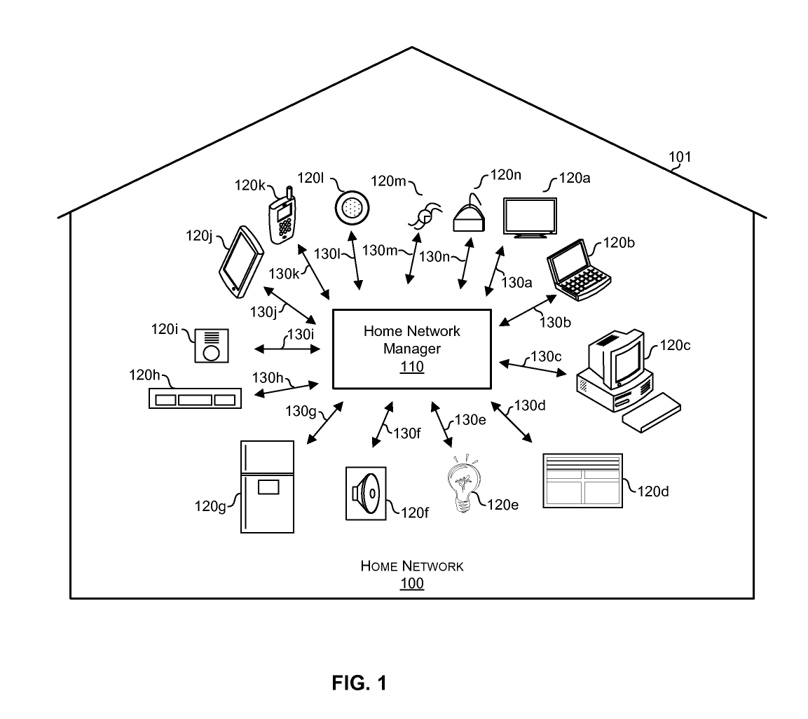

FIG. 1 illustrates an example home network. Referring to FIG. 1, there is shown a home network 100.

The home network 100 may correspond to a location 101. The location 101 may, for example, correspond to a residence (e.g., home, apartment) or non-residence premises (e.g., small business, school, library, factory, etc.). In this regard, the home network 100 may, for example, comprise a plurality of home network elements, such as, for example, a plurality of home network elements 120a-120n. The home network elements (e.g., home network elements 120a-120n) may, for example, comprise one or more devices (e.g., electrical devices), systems, fixtures, appliances, and/or other circuitry. The home network elements (e.g., home network elements 120a-120n) may comprise, for example, one or more televisions 120a, one or more computers (e.g., laptop computer 120b, desktop computer 120c), one or more personal and/or handheld devices (e.g., tablet 120j, mobile/smart phone 120k, smart watch 120m), one or more multimedia devices and/or components (e.g., speakers 120f), one or more structural fixtures (e.g., windows/window blinds 120d,), one or more lighting and/or electrical fixtures 120e, one or more appliances (e.g., refrigerator 120g), one or more environmental sensory devices 120h (e.g., thermometers, humidity meters), one or more security devices 120i (e.g., a smoke detector, a carbon monoxide detector, a security alarm, a motion detector), one or more sensors and/or controller (e.g., intelligent motion sensor 120l, RGBW controller 120n) and/or other devices.

The disclosure is not limited to any particular type of a home network. Furthermore, the disclosure is not limited to any particular combination of home network elements. It is to be understood that although the network is referred to as a “home network” throughout the disclosure, the disclosure is not limited in this way. Specifically, the network may comprise any other network that may be operable to control one or more network elements. For example, the network of the disclosure (whether or not referred to as a “home network”) may be implemented in a residential, non-residential, commercial, industrial and/or any other setting. Similarly, the network elements may comprise network elements (whether or not referred to as a “home network elements”) implemented in a residential, non-residential, commercial, industrial and/or any other setting.

The home network 100 may comprise a home network manager 110. The home network manager 110 may comprise suitable circuitry, interfaces, logic, and/or code for implementing various aspects of the present disclosure. For example, the home network manager 110 may be configured for use in managing, servicing, and/or interacting with one or more home network elements for home automation, for example.

Although the home network manager 110 is illustrated as a single device, the disclosure is not limited in this way. For example, the home network manager may comprise one or more home network manager that may each interact with one or more home network elements (e.g., home network elements 120a-120n). In an example embodiment of the disclosure, each of the one or more home network managers may be associated with particular one or more home network elements. In another example, one or more of the one or more home network managers may be associated with any one or more home network elements (e.g., home network elements within range of a particular home network manager, with best communication path).

In an example embodiment of the disclosure, one or more home network managers (e.g., home network manager 110) may form a network of manager to support management and/or control of one or more network element in one or more locations. The locations may be related. For example, the locations may be defined for a particular region or regions (e.g., building, floor) and/or for a particular association. The association may, for example, be defined based on a user. (e.g., home location, work location).

In an example embodiment of the disclosure, the home network manager 110 may be pre-programmed and/or programmable, via a computing device (not shown) such as a mobile phone, a smart phone, a PC or a tablet, to control one or more home network elements. In this regard, the network manager 110 may be programmed or configured via a computing device (not shown) such as a mobile phone, a smart phone, a PC or a tablet.

The home network manager 110 may interact with one or more of the home network elements 120a-120n via corresponding links 130a-130n, which may be supported by the home network manager 110 and/or the corresponding home network element(s). For example, the links 130a-130n may be implemented and/or configured to operate using a wireless protocol, such as, for example, a Z-wave protocol. In an example embodiment of the disclosure, the home network 100 may be implemented as Z-Wave network. However, the disclosure is not limited in this way. For example, the home network 110 may comprise one or more wired and/or wireless links and/or protocol. Wireless links and/or protocols, may comprise, for example, WPAN (e.g., Bluetooth or ZigBee), low power links (e.g., Bluetooth LE (BLE), Bluetooth Smart, iBeacon), near field communication protocols (e.g., NFC) and/or WLAN (WiFi/802.11) protocols and/or any other wireless links and/or protocols suitable for implementation consistent with the disclosure. Wired protocols and/or links may comprise, for example, Ethernet, Universal Serial Bus (USB), and/or any other wired links and/or protocols suitable for implementation consistent with the disclosure.

In an example embodiment of the disclosure, home network manager 110 may interact with one or more home network elements (e.g., home network elements) directly and/or indirectly. For example, the home network manager 110 may interact with one or more home network elements directly through a corresponding link (e.g., wireless, wired link/connection).

In another example, the home network manager 110 may interact with one or more home network elements indirectly through, for example, a converter (e.g., global cache.) In this regard, the home network manager 110 that supports one or more particular network interfaces and/or other interfaces (e.g., USB) may be operable to interact with a particular network element (and/or another device) that may otherwise be incompatible with one or more of the one or more particular network and/or other interfaces supported by the home network manger 110. The interaction may be achieved through, for example, a converter and/or a translator. The converter and/or the translator may each comprise suitable logic, circuitry, interfaces, and/or code that may be operable to facilitate communication between a home network manager (e.g., the home network manger 110) and a home network element (home network elements 120a-120n).

In another example, the home network manager 110 may interact with one or more home network elements indirectly through, for example, other network elements. In this regard, the home network manager 110 may interact with one or more home network elements on, for example, a mesh network. An example mesh network (not shown) may facilitate communication (e.g., transmission of messages, signals, data frames) to and/or from the home network manager (e.g., the home network manager 110) to and/or from a particular network element where the communication may, for example, pass through one or more other network elements before reaching the particular network element and/or the home network manager.

In an example embodiment of the disclosure, the home network manager 110 may be operable to support one or more communication methods from one or more other home network devices (e.g., home network elements 120a-120n). For example, one or more home network elements may communicate with the home network manager 110 utilizing a particular wireless link and/or protocol (e.g., Z-wave) and/or a particular wired link and/or protocol (e.g., Ethernet), while one or more other home network elements may communicate with the home network manager 110 utilizing a different particular wireless link and/or protocol (e.g., WiFi) and/or a different particular wired link and/or protocol (e.g., USB).

In an example embodiment of the disclosure, the same one or more home network elements may communicate with the home network manager 110 by, for example, using one or more wired and/or wireless links and/or protocols at the same and/or at different times. For example, a particular network element may communicate with the home network manager 110 using a Z-Wave communication protocol for a particular communication and may communicate with the home network manager 110 using a WiFi communication protocol for another particular communication.

In an example embodiment of the disclosure, one or more home network elements (e.g., home network elements 120a-120n) may communicate with one or more home network elements (e.g., home network elements 120a-120n) directly. In this regard, the one or more network elements may utilize one or more communication links (e.g., wireless, wired) (not shown) and/or one or more network interfaces and/or other interfaces without directing (e.g., routing the communication thought, for example, a home network manager (e.g., the home network manger 110). For example, a home network element may be operable to detect existence of one or more other network elements (e.g., on the same and/or different network) and may initiate, send and/or receive communication to and/or from the one or more other network elements.

In an example embodiment of the disclosure, one network element may be out of range of a home network manager and may communicate with one or more other network elements to determine whether the one or more other network elements are within range of a particular (e.g., a home network manager previously within range of the one network element) and/or any network manager. The range detection and/or discovery may continue from one network element to another. For example, a particular home network element may need to communicate through more than one other home network element in order to, for example, communicate with a desired home network element and/or a desired, particular and/or any home network manager (e.g., the home network manager 110). The disclosure is not limited to a communication for a purpose of range discovery/detection. The communication may comprise any type of communication and may be used for a variety of other purposes (e.g., communicating with a different network element, communicating with a home network manager, controlling an out of range device, controlling another network element).

In an example embodiment of the disclosure, one or more home network elements (e.g. home network elements 120a-120n) and/or other devices that may be operable to communicate on the network (and/or an associated network as described herewith) and/or that may not be operable to communicate on the network but may otherwise be tractable (e.g., GPS, iBeacon, electronic tag), with one or more other network elements, devices and/or a network manager (e.g., home network manager 110) associated with a particular network (e.g., home network 100) (and/or an associated network as described herewith), may communicate with each other, other devices (e.g., on the same network, another network and/or otherwise connected and/or tractable) and/or the network manager, and/or may be operable to determine a precise location of a particular network element, device and/or network manager utilizing various communication protocols and/or interfaces.

For example, one or more network elements (and/or other devices operable on the network, an associated network as described herewith and/or otherwise traceable) may be operable to generate and/or receive information and/or one more signals and/or messages that may be utilized in determining a location of a particular network element, device and/or network manager. In this regard, a near field communication and/or a low power interface protocol (e.g., BLE, iBeacon) may be utilized for communication between the elements, devices and/or network managers. Furthermore, one more tags (e.g., small electronic devices) may be utilized, to facilitate location of particular elements, devices and/or network managers. For example, a network element, device and/or home network manager may generate a signal and/or a message (on the network, on an associated network and/or through a built in, external, portable and/or otherwise attachable tag) that may be received by another network element, device and/or network manager.

In an example embodiment of the disclosure, one or more home network elements, devices and/or manager may cooperate (e.g., exchange information) to, for example, collectively and/or individually determine a precise location of a particular network elements, device and/or network manager based on the received one or more signals and/or messages. As an example only, a particular network element, device and/or home network manager may generate a signal and/or a message that may be received by other network element, device and/or home network device within a particular time frame. The information about the time it took to, for example, receive the particular one or more signals and/or messages (and/or the information gather from the one or more signals and/or messages, such as, for example, signal strength) may be used to determine the precise location (e.g., distance to/from the network element, device, network manager that received the particular one or more signals and/or message) of the particular network element, device and/or network manager.

In operation, the home network manager 110 may be operable to manage a home network (e.g., the home network 100), for example, for home automation. The home network manager 110 may be utilized, for example, as an interface platform for interacting with various network elements (e.g., the home network elements 120a-120n). In this regard, the home network manager 110 may support establishing and/or configuring one or more communication connections/links (e.g., the links 130a-130n) with the one or more elements of the home network 110. Once established, the connectivity between the home network manager 110 and the home network elements (e.g., elements 120a-120n) may, for example, be utilized to enable centralized monitoring, control, and/or management of the home network elements, and/or of the home network 100 as a whole. For example, the home network manager 110 may be operable to control operations of certain elements (e.g., turn on television 120a, switch to particular channel(s) at particular days/times, and/or record if recording is supported); monitor environment in the home network, such as by obtaining environmental readings (e.g., temperature, humidity, etc.) via example environmental sensory devices 120h, and may process these readings (e.g., to determine if/when to adjust other home network elements accordingly); adjust one or more example lighting and/or electrical fixtures 120e (e.g., turn lights on or off); lower/raise example window (blinds) 120d; adjust operations of example appliances (e.g., refrigerator 120g), such as, for example, based on a preconfigured power efficiency/optimization profile; monitor for any indications of a security/safety problem, based on, for example, input from example security devices 120i, and/or act accordingly (e.g., send notifications to users, such as by texting example smart phone 120k, and/or automatically notify authorities, e.g., by dialing ‘911’ and/or contacting preconfigured emergency numbers).

In an example embodiment of the disclosure, the home network manager 110 may provide and/or utilize user interface services in the home network. In this regard, the home network manager 110 may be operable to support use of user interface functions, and/or to generate and/or store information corresponding thereto, which may be utilized to enable interactions between the home network manager 110 and users (e.g., in the home network 100). For example, in some implementations, the home network manager 110 may be configured to generate and/or use a graphic user interface (GUI), for visually displaying information and/or providing interactivity with users (e.g., for providing input thereby). One or more user interfaces may enable configuring the home network manager 110 and/or functions provided by the home network manager 110. In an example embodiment of the disclosure, the one or more user interfaces may enable user interaction with, configuring and/or adjusting other elements in the home network 100 (e.g., elements connected to the home network manager 110). In an example embodiment of the disclosure, a GUI may be operable to control one or more network managers that may, for example, be associated with a particular location and/or user.

In an example embodiment of the disclosure, the user interfaces may be provided via one or more other devices (e.g., computing devices) that may be communicatively coupled to the home network manager 110. As an another example, a GUI generated and/or used by the home network manager 110 may be displayed using existing home network elements, such as, for example, television 120a, laptop 120b, tablet 120j, and/or smart phone 120k.

The disclosure is not limited to a single network (e.g., home network 100) and/or a single network manager (e.g., home network manager 110). For example, one or more networks (e.g., home network 100) and/or one or more network managers (e.g., home network manager 110) may be grouped together. The grouping may correspond to one or more locations (e.g., location 101).

In an example embodiment of the disclosure, a network (e.g., home network 100) may be associated with one or more network managers (e.g., home network manager 110). For example, one network manager may be associated with one or more networks (e.g., home network 100) and/or locations (e.g., location 101),

In an example embodiment of the disclosure, a grouping of networks may comprise one or more network, network managers and/or locations. The grouping may be programmable and/or configurable. For example, one more networks may be defined, one or more network managers may be assigned per network and/or associated with one or more devices with a network and/or a network manager. In this regard, the information may be shared between the different networks, network managers and/or devices assigned to the different networks and/or network managers. For example, information gathered on one network (e.g., by a network device, through an occurrence of a condition, event, an alarm, and/or other predefined and/or preconfigured condition) may cause the information to be communicated on the same and/or another associated network. In this regard, the information may trigger a condition, an alarm, an occurrence of an event and/or any other predefined and/or preconfigured condition (e.g., operation of a device, network element) on the same and/or another associated network.

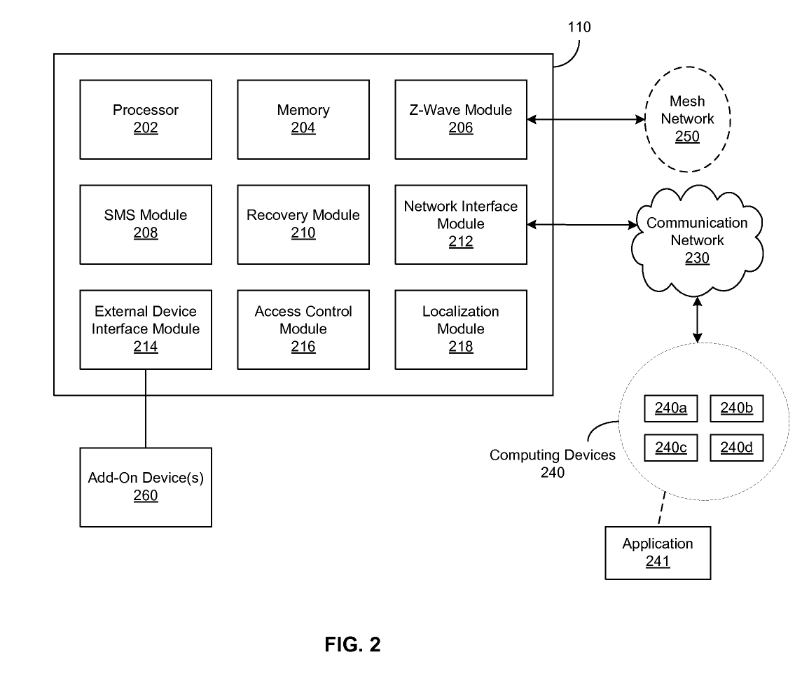

FIG. 2 is a block diagram illustrating an example home network manager, in accordance with an example embodiment of the disclosure. Referring to FIG. 2, there is shown the home network manager 110 as described above with respect to FIG. 1, for example. The home network manager 110 may comprise, for example, a processor 202, a memory 204, a Z-wave module 206, a short message service (SMS) module 208, a recovery module 210, a network interface module 212, an external device interface module 214, an access control module 216 and a localization module 218. There is also shown, in FIG. 2, a mesh network 250, a communication network 230, add-on device(s) 260, an application 241 associated with the home network manager 110, and computing devices 240, of which devices 240a-240d are illustrated. In an example embodiment of the disclosure, the home network manager 110 may be a compact device. For example, the compact device may have the following example dimensions: 90 mm long, 90 mm wide and 33 mm high, for example. It is to be understood that the present disclosure is not limited to any particular set of dimensions on the home network manager and that the example dimensions have been provided only to illustrate the compact nature of the home network manager.

The processor 202 may comprise suitable logic, circuitry, interfaces and/or code that may be operable to manage and/or control operations of various components and/or modules in the home network manager 110. The processor 202 may utilize an operating system (OS) that enables the execution of various applications. In an example embodiment of the disclosure, the processor 202 may comprise an energy efficient processor such as, for example, a Cortex A8 processor. It is to be understood that the present disclosure is not limited to any particular processor.

The memory 204 may comprise suitable logic, circuitry, interfaces and/or code that may be operable to store information such as executable instructions and/or data that may be utilized by the processor 302 and/or other modules or components in the home network manager 110. The memory 204 may comprise RAM, ROM, low latency nonvolatile memory such as flash memory and/or other suitable electronic data storage.

The Z-wave module 206 may comprise suitable logic, circuitry, interfaces and/or code that may be operable to provide Z-wave communication capabilities for the home network manager 110. Z-wave may utilize a mesh network architecture. After an inclusion (paring) process for each of the one or more network elements 120a-120n, the home network manager 110 and the one or more network elements 120a-120n may be coupled and may communicate with each other using Z-wave communication in the mesh network 250 environment.

The SMS module 208 may comprise suitable logic, circuitry, interfaces and/or code that may be operable to provide mobile communication notifications capabilities for the home network manager 110, such as for example, SMS, MMS, e-mail, Bluetooth and/or other communication notifications that may be suitable for notifying a user of a mobile device. After setup by a user via one of the computing devices 240, the SMS module 206 may enable the home network manager 110 to send a mobile communication notification to a pre-determined destination even when the user does not have a viable Internet connection, for example.

The recovery module 210 may comprise suitable logic, circuitry, interfaces and/or code that may be operable to provide system back and recovery capabilities for the home network manager 110. In an example embodiment of the disclosure, the recovery module 210 may comprise a recovery disc. The recovery disc may, for example, comprise a 4 GB MLC recovery disc for holding the system backup. It is to be understood that the present disclosure is not limited to any particular recovery disc. Furthermore, the disclosure is not limited to any particular recovery module. For example, the recover module 210 may, for example, comprise a built in component (e.g., hardware and/or software element(s)) that may be, for example, embedded in, attached to a home network manager. In an example embodiment of the disclosure, the recover module 210 may be located remotely from a home network manager (e.g., in a cloud, remote network location, remote server). The recovery module 210 allows a user to retrieve the operating system of the home network manager 110 in case of technical problems (e.g., when it is not possible to log into the home network manager 110). Through the recovery module 210, the home network manager 110 may be brought back to the factory installed software version, for example.

The network interface module 212 may comprise suitable logic, circuitry, interfaces and/or code that may be operable to provide wired and/or wireless interface with the communication network 230. The communication network 230 may comprise suitable logic, circuitry, interfaces, devices and/or code that may be operable to provide voice and data communication services to various electrical devices, such as the home network manager 110 and the computing devices 240, by using wired or wireless communication technologies (e.g., Ethernet, WiFi, LTE, WiMAX, etc.). The communication network 230 may comprise, for example, local area network (LAN), Internet and/or other multimedia network.

The external device interface module 214 may comprise suitable logic, circuitry, interfaces and/or code that may be operable to provide interface with one or more add-on devices 260. The external device interface module 214 may comprise one or more connectors such as, for example, DIN connectors. In an example embodiment of the disclosure, the one or more add-on devices 260 may be connected to the external device interface module 214 with an open interface. The add-on device(s) 260 may be connected to the home network manager 110, for example, for increasing functionality and/or capacity of the home network manager 110. For example, the add-on device(s) 260 may comprise a user-interface module, a backup module, a hard drive (HD), a signal repeater, communication module (e.g. 3G, LTE, WiFi), access point connection to a building automation control system, emergency power module, USB port(s) that may, for example, support control and/or management of other external devices (e.g., hard drive, local multimedia server), etc.

The access control module 216 may comprise suitable logic, circuitry, interfaces and/or code that may be operable to provide access control capability for the home network manager 110. In this regard, the access control module 216 may be operable to perform user's access control and user's rights management. For example, the access control module 216 may allow a user to grant/block access to some network elements 120a-120n, scenes and/or system settings.

The localization module 218 may comprise suitable logic, circuitry, interfaces and/or code that may be operable to provide location tracking capabilities for the home network manager 110. The localization module 216 may be operable to track pre-configured location information associated with one of the computing devices 240, for example. The localization module 218 may perform the location tracking utilizing geo localization (or geolocation). For example, the localization module 218 may utilize user defined GPS points for activating GPS scenes. For example, the user may define two GPS points HOME and WORK. Based on the tracking performed by the localization module 218, when the user leaves the HOME location, the processor 202 may turns off unneeded network elements (e.g., turn off the light 120e), arms the alarm system 120i once the user enters the WORK location. While calculating the user's return route from the WORK location, the processor 202 may adjust temperature and run pre-programmed scenes, for example.

In operation, a user may setup the home network manager 110 using one or more computing devices such as the computing devices 240. Based on the setup, the processor 202 in the home network manager 110 may be operable to provide management of one or more network elements 120a-120n which may be coupled to the home network manager 110 for home automation. One or more add-on devices 260, which are newly connected to the home network manager 110 via the external device interface module 214, may be detected by the processor 202. The processor 202 may be operable to self-configure the newly connected one or more add-on devices 260. The external device interface module 214 may be operable to connect to the one or more add-on devices 260 with an open interface. When necessary, the user may perform additional setup for the newly connected add-on device(s) 260. The processor 202 may then be operable to provide, with inclusion of the one or more add-on devices 260, the management for the home automation.

The home network manager 110 may be operable to couple to the one or more network elements 120a-120n using Z-wave wireless communication through the Z-wave module 206 in the home network manager 110. In this regard, the home network manager 110 and the coupled one or more network elements 120a-120n may communicate with each other in the mesh network 250 environment.

The processor 202 may be operable to provide user friendly interface to the one or more computing devices 240 for managing and controlling the home network manager 110. In this regard, the one or more computing devices 240 may comprise a PC 240a, a mobile phone 240b, a smart phone 240c, and/or a tablet 240d, for example. The home network manager 110 may be operable to communicate with the one or more computing devices 240 via the communication network 230, for example. The one or more computing devices 240 may manage and control the home network manager 110 either locally or remotely. For example, the user may use the PC 240a to setup the home network manager 110 locally via the LAN. The user may use the smart phone 240c or the tablet 240d to setup the home network manager 110 remotely via the Internet. The home network manager 110 may be managed and controlled by the one or more computing devices 240 utilizing, for example, the downloaded application 241 which is associated with the home network manager 110. The localization module 218 in the home network manager 110 may be operable to track locations of one or more of the computing devices 240. In this regard, the processor 202 may be operable to manage the one or more network elements 120a-120n based on the tracking.

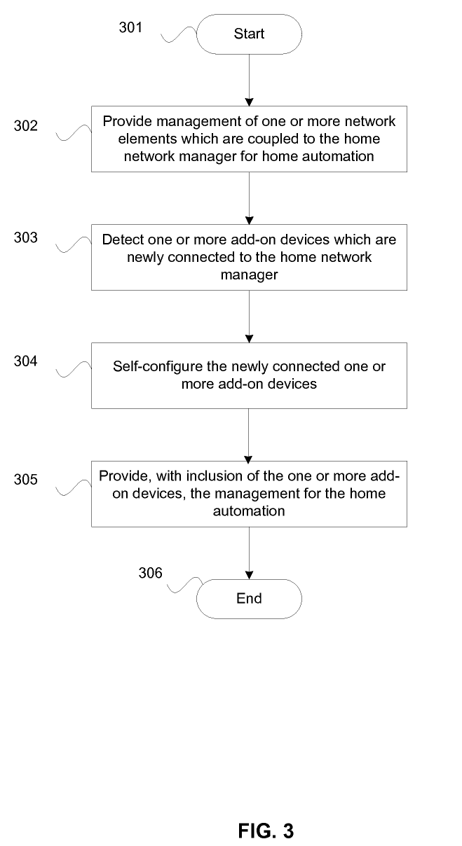

FIG. 3 is a flow chart illustrating example steps for providing management by a home network manager, in accordance with an example embodiment of the disclosure. Referring to FIG. 3, the example steps start at step 301. In step 302, the processor 202 in the home network manager 110 may be operable to provide management of one or more network elements 120a-120n which may be coupled to the home network manager 110 for home automation. In step 303, one or more add-on devices 260, which are newly connected to the home network manager 110 via an external device interface module 214 in the home network manager 110, may be detected by the processor 202. In step 304, the processor 202 may be operable to self-configure the newly connected one or more add-on devices 260. In step 305, the processor 202 may then be operable to provide, with inclusion of the one or more add-on devices 260, the management for the home automation. The example steps may proceed to the end step 306.

In various embodiments of the disclosure, a processor 202 in a home network manager 110 may be operable to provide management of one or more network elements 120a-120n which may be coupled to the home network manager 110 for home automation. One or more add-on devices 260, which are newly connected to the home network manager 110 via an external device interface module 214 in the home network manager 110, may be detected by the processor 202. The processor 202 may be operable to self-configure the newly connected one or more add-on devices 260. The processor 202 may then be operable to provide, with inclusion of the one or more add-on devices 260, the management for the home automation.

The home network manager 110 may be operable to couple to the one or more network elements 120a-120n using Z-wave wireless communication through a Z-wave module 206 in the home network manager 110. In this regard, the home network manager 110 and the coupled one or more network elements 120a-120n may communicate with each other in a mesh network 250 environment.

The processor 202 may be operable to provide user friendly interface to one or more computing devices 240 for managing and controlling the home network manager 110. In this regard, the one or more computing devices 240 may comprise one or more of a PC 240a, a mobile phone 240b, a smart phone 240c, and a tablet 240d, for example. The home network manager 110 may be operable to communicate with the one or more computing devices 240 via a communication network 230, for example. The one or more computing devices 240 may manage and control the home network manager 110 either locally or remotely. The home network manager 110 may be managed and controlled by the one or more computing devices 240 utilizing, for example, a downloaded application 241 which is associated with the home network manager 110. A localization module 218 in the home network manager 110 may be operable to track locations of one or more of the computing devices 240. In this regard, the processor 202 may be operable to manage the one or more network elements 120a-120n based on the tracking.

The external device interface module 214 may be operable to connect to the one or more add-on devices 260 with an open interface. The home network manager 110 may be a compact device with a size of 90 mm long, 90 mm wide and 33 mm high, for example. The processor 202 may comprise an energy efficient processor (e.g., a Cortex A8 processor). The home network manager 110 may comprise a recovery module 210 for providing system backup and recovery, and a short message service (SMS) module 208 for providing SMS notification. The home network manager 110 may also comprise an access control module 216 for providing user's access control and user's rights management.

Other embodiments of the disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for a home network manager for home automation.

Accordingly, aspects of the present disclosure may be realized in hardware, software, or a combination of hardware and software. The present disclosure may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

Aspects of the present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

1. A method of managing one or more elements in a home network for home automation using an electronic home network manager, the electronic home network manager storing data, wherein the data comprises configuration data associated with the one or more elements and having a processor, the method comprising:
monitoring with the processor configuration and control functions associated with the electronic home network manager;
coupling the one or more elements to the electronic home network manager via the home network;
detecting via the electronic home network manager whether the one or more elements has been coupled to the electronic home network manager via the home network;
in response to detecting that the one or more elements has been coupled to the electronic home network manager, configuring the coupled one or more elements to communicate with the electronic home network manager with the configuration data stored in the electronic home network manager; and
communicating via the electronic home network manager a programmed function to the configured elements.

2. The method according to claim 1, wherein coupling the one or more elements to the electronic home network manager comprises coupling the one or more elements to the electronic home network manager through a Z-wave wireless communication protocol.

3. The method according to claim 1, further comprising accessing the electronic home network manager via an electronic device including one or more of a PC, a mobile phone, a smart phone, and a tablet.

4. The method according to claim 3, further comprising tracking via the electronic home network manager a geo-location of the electronic device.

5. The method according to claim 4, further comprising managing via the electronic device the one or more configured elements based on the tracking.

6. The method according to claim 1, wherein the electronic home network manager further comprises a recovery module, the method further comprising backing up information of the electronic home network manager to the recovery module.

7. The method according to claim 1, wherein the electronic home network manager further comprises a message service module, the method further comprising delivering a notification to the one or more configured elements with the message service module.

8. The method according to claim 1, wherein the electronic home network manager further comprises an access control module, the method further comprising controlling access to the electronic home network manager with the access control module.

9. The method according to claim 1, wherein the electronic home network manager is further coupled to a different configured networked element, the method further comprising communicating at least a portion of the programmed function via the home network between the configured one or more elements and the different configured networked element.

10. A home management system comprising:
a processor configured to monitor configuration and control functions associated with the electronic home network manager;
an electronic element having one or more electronic circuits operable to perform a home automation function;
an external device interface being couplable to the electronic element, and, when coupled, operable to provide control information to the coupled electronic element;
a processor, having a) a memory storing data, wherein the data comprises configuration data associated with the electronic element, and b) one or more processor electronic circuits operable to i) detect whether the electronic element has been coupled to the external device interface, ii) in response to detecting the electronic element has been coupled to the external device interface, configure the coupled electronic element using the stored configuration data, wherein the configuration data enables the coupled electronic element to communicate with the processor, and iii) communicate a programmed function to the configured electronic element.

11. The home management system according to claim 10, wherein the external device interface comprises one or more external interface device circuits operable to communicate with the electronic element through a Z-wave wireless communication protocol.

12. The home management system according to claim 10, further comprising an electronic device comprising one or more electronic device circuits operable to access information from the processor, and wherein the electronic device comprises one or more of a PC, a mobile phone, a smart phone, and a tablet.

13. The home management system according to claim 12, further comprising a localization module comprising one or more localization module circuits operable to track via a geo-location of the electronic device, and wherein the processor is further configured to manage the configured electronic element based on the tracking.

14. The home management system according to claim 10, wherein the memory is further operable to store operational information of the home management system, and a recovery module comprising one or more recovery module circuits operable to back up the stored operational information to the recovery module.

15. The home management system according to claim 10, further comprising a message service module comprising one or more message service module circuits operable to deliver a notification to the configured electronic element.

16. The home management system according to claim 10, further comprising an access control module comprising one or more access control module circuits operable to control access to the home management system.

17. The home management system according to claim 10, further comprising a different configured networked element, and wherein the configured electronic element comprises one or more circuits operable to communicate at least a portion of the programmed function to the different configured networked element.

18. A non-transitory computer readable medium for managing one or more elements in a home network for home automation using an electronic home network manager having a processor configured to monitor configuration and control functions associated with the electronic home network manager, the non-transitory computer readable medium having stored thereon, a computer program having data, wherein the data comprises configuration data associated with the one or more elements, at least one code section, the at least one code section being executable by a computer for causing the computer to perform steps comprising:
coupling the one or more elements to the electronic home network manager;
detecting whether one or more elements has been coupled to the electronic home network manager via the home network;
in response to detecting one or more elements has been coupled to the electronic home network manager, configuring the coupled one or more elements with the configuration data stored in the electronic home network manager; and
communicating a programmed function the configured one or more elements.

19. The non-transitory computer readable media according to claim 18, wherein the electronic home network manager is further coupled to a different configured networked element, the steps further comprising communicating at least a portion of the programmed function via the home network between the configured one or more elements and the different configured networked element.

20. The non-transitory computer readable media according to claim 18, wherein the electronic home network manager further comprises a message service module, the steps further comprising delivering a notification to the one or more configured elements with the message service module.
